(19) United States
(12) Patent Application Publication
(10) Pub. No.: US 2007/0074210 A1
(43) Pub. Date: Mar. 29, 2007

(54) Optimal stateless search

(75) Inventor: Ernest S. Cohen, Wyncote, PA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/233,904

(22) Filed: Sep. 23, 2005

(51) Int. Cl. G06F 9/46

(52) U.S. Cl. 718/100

(57) ABSTRACT

A method of testing software in a concurrent system includes the generation of ordered schedules of threads and operations where only the minimal schedule of each conflict-equivalence class is actually executed. Moreover, these schedules are themselves executed in order. Rather than actually enumerating schedules, all schedules other than the first are obtained from previous schedules by dynamically detecting race conditions. A next schedule is determined from the last schedule generated by removing the minimal set of operations that will allow the race condition to be resolved. The resulting new schedule must be lexicographically less than an equivalent conflict schedule. The method searches only through safe schedules; a safe schedule has the property that regardless of which thread is chosen to run next, the resulting schedule is still normal. In one embodiment, vector timestamps may be used to efficiently detect these race conditions, and to efficiently construct the new schedule traces.

### BACKGROUND OF THE INVENTION

A concurrent system is one in which several independent threads of control execute at the same time, at independent speeds, interacting either through messages or through operations on a shared state. It is well known that concurrent systems are harder to understand and debug than sequential systems, because the order in which different threads execute certain operations (the “schedule” under which the threads are run) can affect the correctness of the computation. Concurrency-related bugs (race conditions, deadlocks, and so on) are often hard to find, because they typically manifest only under unusual schedules not considered by the designer.

The standard way to find such concurrency-related bugs is to run the system under so-called “stress test”, where a system is run under heavy loads in an attempt to elicit unusual behaviors. However, stress testing has many drawbacks:
it is inefficient, since the same uninteresting schedules are run many times;
there is no way to know whether all “relevant” schedules have been covered;
bugs that are hit are hard to reproduce; this makes it hard to use the stress test for so-called “regression testing”.

Several alternative technologies have been proposed for finding concurrency errors. One prominent technology is model checking, where the entire reachable state space of a system is explored. This is usually done by keeping track of the states that have been previously reached, so as to avoid repeatedly searching from the same state. However, this approach is several disadvantages, particularly for systems with complex states:
it is generally difficult to check whether a state has been previously explored because the state can depend on a large amount of data;
it is difficult to record the state in a way that is not sensitive to “irrelevant” differences in the state (e.g. the order in which different pieces of memory are allocated);
for so-called “symbolic” model checking, which allows many states to be analyzed at the same time, the state must be relatively small, for example, on the order of at most 100-200 bits of state information, and constructing a suitable abstract state is a difficult task.

An alternative is a technique known as “stateless search”. In this method, the search engine does not keep track of which states have been explored. Instead, a test is run through a number of different finite schedules (the finiteness typically guaranteed by using a test that is guaranteed to terminate), and between test runs the system is reset to the same initial state. Stateless search has several well-known advantages over other technologies; in particular, it can be used directly on large software systems without having to construct an abstract model, and it does not require capturing or recognizing previously visited states.

Without further refinement, however, stateless search is impractical, since the number of schedules typically grows exponentially with the length of the test, even in systems with a relatively small number of states. This is a reflection of the fact that the same state can be reached through many different schedules. Since most concurrency errors do not depend on the path by which the erroneous state was reached, exploring different paths to the same state represents redundant work. Thus, the primary challenge in stateless search is to eliminate as many of these redundant schedules as possible.

In practice, most (though not all) of the redundant schedules can be eliminated using the following well-known idea, sometimes known as “partial order equivalence”. By definition, two operations performed by different threads “commute” if, for any state, performing the operations in either order, starting from the chosen state, results in the same state. Imagine that one selects a conflict relation on operations, such that every pair of operations either conflict or commute, or possibly both. For example, in a system where threads interact only through reads and writes to shared memory, one might say operations of different threads conflict only if they operate on a common piece of data and at least one of the operations is a write. If two schedules differ only in the order in which nonconflicting operations are performed, one can say that the two schedules are conflict equivalent. Conflict equivalence is an equivalence relation, so a maximal set of pairwise equivalent is called a conflict equivalence class

For typical test purposes (e.g. finding assertion violations, deadlocks, and so on), if a system executed under some schedule passes the test, then the system will still pass the test when run under any equivalent schedule. Therefore, instead of running a test under every possible schedule, it suffices to run it under a single schedule from each equivalence class. For example, in a concurrent system consisting of two threads where all pairs of operations from the two threads commute, all schedules are equivalent, so only one test run is necessary. An optimal stateless search method is one that executes exactly one schedule from each conflict equivalence class. To be practical, the method should require computation time that is polynomial in the total length of the schedules actually executed, rather than in the total number of schedules, which might be exponentially greater.

The technique of using operation independence to avoid redundant exploration is generally known as (partial-order) reduction. A number of reduction techniques have been proposed for model checking, some suitable for stateless search. However, existing techniques for stateless search are far from optimal—they can cause execution of a large number of equivalent schedules. For some kind of systems, there are trivial ways to perform optimal stateless search (for example, by first enumerating all schedules and checking their equivalence one pair at a time), but these methods are not practical.

Of known algorithms, the one closest in spirit is described in P. Godfroid, C. Flanagan, “Dynamic Partial-Order Reduction for Model Checking Software.” ACM Principles of Programming Languages, 2005. The authors there suggested dynamically detecting race conditions using vector timestamps, and using these to generate further paths to explore. However, their algorithms can search through redundant schedules, even in systems with only two threads. The present invention provides the first practical optimal stateless search method.

### SUMMARY OF THE INVENTION

In the present invention, schedules are ordered, and only the minimal schedule of each conflict-equivalence class of complete schedules is actually executed. Such schedules are said to be normal. Moreover, these schedules are themselves executed in order. Rather than actually enumerating schedules, all schedules other than the first are obtained from previously explored schedules by dynamically detecting race conditions. In this case, the new schedule is obtained from the previous schedule by removing the minimal set of operations that will allow the race condition to be resolved with a different winner, and adding the resulting schedule to a set of schedules to be explored in subsequent test runs.

One aspect of the method is that the current schedule being explored is always a prefix of a complete normal schedule; this guarantees that the method never reaches a “dead end” where the current schedule cannot be completed to a normal schedule. In order to guarantee this invariant, the method searches only through schedules that are guaranteed to remain normal, regardless of which thread is run next; such schedules are said to be safe.

Vector timestamps may be used to efficiently detect the race conditions, and to efficiently construct the new schedules. This also allows the set of schedules yet to be explored to share most of their structure. However, in the worst case, the schedules can require storage space exponential in the length of the longest schedule.

In the special case of two threads, a more efficient algorithm is used that reduces the storage to linear in the maximum trace length.

### BRIEF DESCRIPTION OF THE DRAWINGS

In the drawings:

FIG. 1 is a flow diagram of a general method demonstrating aspects of the invention;

FIGS. 2a and 2b are flow diagrams of a two thread method demonstrating aspects of the invention; and

FIG. 3 is a block diagram showing an example computing environment in which aspects of the invention may be implemented.

### DETAILED DESCRIPTION

### Exemplary Embodiments

Assumptions

For the purpose of describing the invention, the following assumptions are made. There is an underlying finite set of “operations” and variables a and b which range over the finite set of operations. There is a function th on operations that assigns to each operation a a number th(a), called the “thread” of a. A notational shorthand for th(a)<th(b) is a<b.

Operations represent atomic actions of threads that are subject to interference from actions of other threads, or can interfere with other threads, and are therefore potentially sensitive to scheduling decisions. A thread may engage in other actions that are guaranteed not to interfere with, and not to be interfered by, operations of other threads. For example, threads often contain thread-local variables that are guaranteed not to be effected by other threads; so an operation that accesses only thread-local variables cannot interfere with operations of other threads. A well-known optimization is to omit such “invisible” actions from schedules, and this is done in some embodiments of the present invention.

In other embodiments, threads might be represented in other ways, such as by structures. In one aspect of the invention, threads are linearly ordered; that is, for any two threads a and b, exactly one of (a=b, a<b, b<a) holds. Any nonempty set of threads has a minimal element; a thread a in the set such that for every other thread b in the set, a<b.

Certain finite sequences of operations are designated as “schedules”. The set of schedules is constrained by the following assumptions, where s..a is the schedule obtained by adding the operation a to the end of operation sequence s:
If s..a is a schedule, then s is a schedule. (i.e., schedules are prefix-closed.)
If s..a and s..b are schedules and th(a)=th(b), then a=b. (i.e. for any schedule, there is at most one “next” operation for any given thread.)
If th(a)≠th(b), then s..a..b is a schedule iff s..b is a schedule. (i.e., the “next” operation, if any, of a given thread is unaffected by operations of other threads.)
No operation occurs more than once in any schedule. Although this is not essential, it is included to simplify the exposition.
   A schedule represents the sequence of operations performed by the threads of a system in a possible execution of the system. As such, in typical embodiments, the set of schedules is not given explicitly, but is defined implicitly by the system itself. That is, schedules are constructed by repeatedly, nondeterministically choosing an arbitrary thread of the system that has not yet terminated and executing the “pending” operation of that thread.

There is a binary, symmetric conflict relation on operations. A conflict between a and b may be represented as a#b. Any conflict relation may be chosen, subject to the following conditions:
If th(a)=th(b), then a#b.
If s..a..b..t is a schedule and s..b..a..t is not a schedule, then a#b. (i.e., exchanging adjacent nonconflicting operations in a schedule produces a schedule.)

In general, many different conflict relations may be chosen for the same set of operations. For example, if operations read or write to memory locations, two operations may be defined to conflict iff they are performed by same thread, or if at least one of the operations is a write and they operate on overlapping memory locations. It is possible to make finer distinctions to as to make fewer operations conflict; for example, conflicts could be defined so that two operations that add constants to the same memory location do not conflict. In general, if fewer pairs of operations conflict, equivalence classes are larger, and fewer test executions will be generated by the method. However, more complex conflict operations might require more complex application instrumentation or more complex calculations.

Method

Schedules are totally ordered by replacing each operation of a schedule with its thread and comparing the resulting strings using lexicographic (i.e dictionary-like) ordering. More precisely, the total ordering on schedules is the minimal partial ordering satisfying
if s and s..a are schedules, then s<s..a
if s..a..t and s..b..u are schedules and a<b, then s..a..t<s..b..u

If s is a schedule, then the following may be defined:
s is “complete” iff there is no operation a s.t. s..a is a schedule.
a is the “pending” operation of thread tr in s iff s..a is a schedule and th(a)=tr.
Thread tr has “terminated” after s iff tr has no pending operation in s.
a is the “minimal extension” of s iff s..a is a schedule and, for every operation b such that s..b is a schedule, a<b. (That is, the minimal extension of s is the pending operation of the lowest-numbered thread that is not terminated after s.)
Two schedules are “conflict equivalent” iff one can be converted to the other by repeatedly swapping adjacent nonconflicting operations.
s is “normal” if for every a,b,s1,s2,s3 such that s=s1..a..s2..b..s3 and b<a, either there exists some c in a..s2 such that c#b. Intuitively, s is normal iff there is no schedule t conflict equivalent to s such that t<s.
s is “safe” iff s is normal and, for every operation a such that s..a is a schedule, s..a is normal. Note that a complete normal schedule is safe, that the empty schedule is safe, and that if s is safe and a is the minimal extension of s, then s..a is safe.
a “precedes” b in s iff s is of the form s1..a..s2..b..s3, for some s1,s2,s3.
a→b in s iff a precedes b in s and a#b.
a→* b in s iff there is a possibly empty sequence of operations c1,c2, . . . in s such that a→c1→c2→ . . . b (i.e., if a precedes b in every schedule equivalent to s.) This relation is commonly stated as “a causally precedes b in s”. Note that a→*a.
a “immediately causally precedes” b in s if a→b in s and there is no other c in s such that a→* c→* b. Intuitively, this means that a#b and there is a schedule equivalent to s in which a comes immediately before b.
s “before” a is the subsequence of operations of s that are not causally preceded by a in s.

One aspect of the invention is enumeration of the complete normal schedules. The invention does this by enumerating all safe schedules, since a complete schedule is normal iff it is safe. The set of safe schedules is constructed as a set satisfying the following properties:
The empty schedule is in the set.
If s is in the set and a is the minimal extension of s, then s..a is in the set.
If s..a is in the set, and b immediately causally precedes a in s..a, let u=(s after b). If u..a is safe and s..a<u..a, then u..a is in the set.

Any set of schedules that satisfies these properties contains all safe schedules. Moreover, the smallest set satisfying these conditions contains only safe schedules, so this minimal set consists exactly of the set of all safe schedules. In some embodiments of the method, any of the checks (e.g., the check that u..a is safe) can be omitted, possibly resulting in faster computations but the possible inclusion of nonsafe, and therefore redundant, schedules.

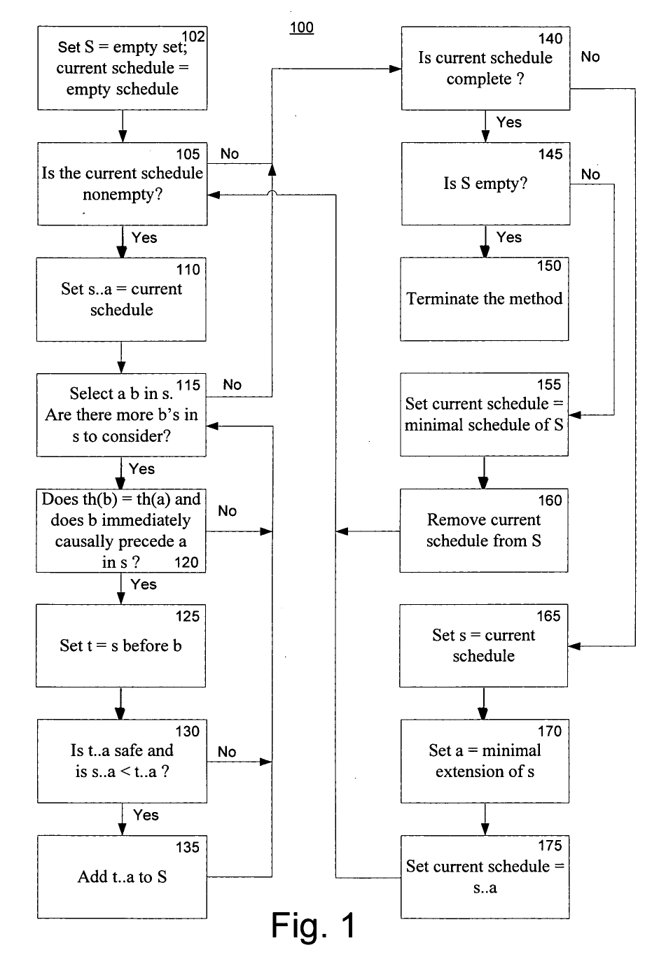

One method 100 to enumerate the safe schedules is illustrated in FIG. 1. At each step of the method, there is a schedule currently being explored, called the current schedule, and a set S of safe schedules yet to be explored or examined. Initially, the current schedule is the empty schedule and S is the empty set [step 102]. The algorithm then iterates the following steps:
1. If the current schedule is nonempty [step 105], it is of the form s..a [step 110]. For every operation b in s [step 115] such that b is in a thread different from the thread of a and b immediately causally precedes a in s [step 120], let t be s before b [step 125]. Then if t..a is safe and s..a<t..a [step 130], add t.a to S [step 135].
2. If the current schedule is complete [step 140], and S is empty [step 145], terminate the method [step 150]. If the current schedule is complete and S is not empty [step 145], set the current schedule to be the minimal schedule in S [step 155], removing that schedule from S [step 160], and go to step 105.
3. Lets be the current schedule [step 165], and let a be the minimal extension of s [step 170]; set the current schedule to s..a [step 175] and go to step 105.

As an example of the method 100, assume a system consisting of three threads, numbered 1-3. Thread 1 performs two operations, a and b, in that order.; Threads 2 and 3 each perform a single operation; c and d respectively. Suppose the only conflicts are a#b, a#d and b#c.

In this example, note that the schedule db is not normal, because it is conflict equivalent to bd, which is lexicographically smaller. Therefore, d is not safe.

Processing would proceed as follows in Table 1. Step is the number of the step that is about to be executed, Schedule is the current schedule, S is the set of schedules yet to be explored. In comments for step 1, “ICP” means the immediate causal predecessors of the last operation of the current schedule that are not from the same thread as the last operation.

TABLE 1
Three Thread Example

| Step | Schedule | S | Comments |
|---|---|---|---|
| 1 | <empty> | { } | <empty> is empty |
| 2 | <empty> | { } | <empty> incomplete |
| 3 | <empty> | { } | a the minimal extension of <empty> |
| 1 | a | { } | ICP = { } |
| 2 | a | { } | a incomplete |
| 3 | a | { } | b the minimal extension of a |
| 1 | ab | { } | ICP = {a}; a before a = <empty>; b not a trace, hence unsafe |
| 2 | ab | { } | ab incomplete |
| 3 | ab | { } | c is the minimal extension of ab |
| 1 | abc | { } | ICP = {b} ab before b = a. ac safe, abc < ac, so ac added to S |
| 2 | abc | {ac} | abc incomplete |
| 3 | abc | {ac} | d the minimal extension of abc |
| 1 | abcd | {ac} | ICP = {a}; abc before a = <empty>; d unsafe (above) |
| 2 | abcd | {ac} | abcd complete; ac the minimal schedule in S |
| 1 | ac | { } | ICP = { } |
| 2 | ac | { } | ac incomplete |
| 3 | ac | { } | b the minimal extension of ac |
| 1 | acb | { } | ICP = {c}; ac before c = a; ab < acb, so ab not added to S |
| 2 | acb | { } | acb incomplete |
| 3 | acb | { } | d the minimal extension of acb |
| 1 | acbd | { } | ICP = {a}; acb before a = c; acbd < cd; cd simple |
| 2 | acbd | {cd} | acbd complete; cd the minimal schedule of S |
| 1 | cd | { } | ICP = { } |
| 2 | cd | { } | cd incomplete |
| 3 | cd | { } | a the minimal extension of cd |
| 1 | cda | { } | ICP = {d}; cd before d = c; ca not normal, not added to S |
| 2 | cda | { } | cda incomplete |
| 3 | cda | { } | b the minimal extension of cda |
| 1 | cdab | { } | ICP = {c}; cda before c = da; cdab < dab; dab simple |
| 2 | cdab | {dab} | cdab complete; dab the minimal schedule of S |
| 1 | dab | { } | ICP = { } |
| 2 | dab | { } | dab incomplete |
| 3 | dab | { } | c the minimal extension of dab |
| 1 | dabc | { } | ICP = {b}; dab before b = da; dabc < dac; dac simple |
| 2 | dabc | {dac} | dabc complete; dac the minimal schedule of S |
| 1 | dac | { } | ICP = { } |
| 2 | dac | { } | dab incomplete |
| 3 | dac | { } | b the minimal extension of dac |
| 1 | dacb | { } | ICP = {c}; dac before c = da; dab < dacb, not added to S |
| 2 | dacb | { } | dacb complete; S empty; algorithm terminates. |

In some embodiments of the invention, the well-known technique of using vector clocks is used to efficiently check whether one operation of a schedule causally precedes another, or if two operations are adjacent, and for computing the “before” function. Vector clock are discussed in F. Mattem, “Time and global states in distributed system”, In Proc. Int. Workshop on Parallel and Distributed Algorithms, North-Holland, pp. 215-226, 1989.

In some embodiments of the invention, a schedule is represented using the following data structure. Each operation of a schedule is represented by a data item that stores a link to the last operation of each thread that conflicts with it. A schedule is represented by an array of such data items, one for each thread, representing the last operation of each thread. Each of these items also contains a vector timestamp. The data items are all treated as immutable, so that they can be shared between executions, Equivalent schedules are merged, so that no two data items are identical, and their storage is reclaimed through the well-known method of automatic reference-counted garbage collection. Schedules in S are represented as pseudo data items of the same type, to prevent the reclamation of the data items to which they refer. To construct the schedule corresponding to some prefix of an existing schedule, the embodiment walks back through each thread to its last operation in the prefix. To construct the schedule corresponding to deleting all operations following some thread operation, the method walks back through each thread until its vector timestamp gives an index for the thread of an operation that is earlier than the index of an operation. The search backward through individual threads can be made faster through well-known data structure techniques such as skip lists or binary search trees.

In some embodiments of the invention, where conflict between operations is detected by first filtering on the data items that an operation operates upon (such as shared memory), the method maintains a hash table indexed by data item, where the previous operations on the data item are gathered. This makes it more efficient to find potentially conflicting operations. In another embodiment, vector timestamps may be used to efficiently detect these race conditions, and to efficiently construct the new schedule traces.

In some embodiments of the invention, checking in step 1 whether t..a is safe can often be done before actually constructing t. In this embodiment, whether for some operation c, whether t..a..c is normal is checked as follows: (1) if a#c, then t..a..c is normal; (2) if the current timestamp on the thread executing c indicates that c is not causally preceded by a, then t..a..c is normal. If both of these tests fail, more complex means (such as actually constructing t..a..c) are used to complete the test.

In some embodiments of the invention, the current schedule reflects the state of a system under test. The determination of what operations can be used to extend the current schedule to a longer schedule is made by direct examination of the system under test, as is the best-known method for all kinds of stateless search. In such embodiments, the description above assumes that the behavior of the system is deterministic, except for nondeterminism introduced through scheduling.

In some embodiments of the invention, operations or internal thread behavior are made explicitly nondeterministic. Well-known methods for extending deterministic stateless search to nondeterministic thread behavior (e.g. having the scheduler explicitly resolve this nondeterminism) can be applied to the current invention also.

In some embodiments of the invention, the optimality condition can be relaxed, to make the processing of each schedule more efficient (though possibly resulting the execution of schedules that are not simple, or even normal). For example, in step (1), the test that s..a<t..a, or the test that t..a is simple, can be omitted. In addition, some embodiments may relax the algorithm such that some schedules are executed even if some equivalent schedules have already been executed. This allows some schedule redundancy.

Method for Two Threads

For two threads, there is a simpler, faster method. Let the threads be numbered 0 and 1. The method stores only the sequence of thread 0 operations in the current execution, and with each thread 0 operation a of the current schedule, the following data:
The number of thread 1 operations that immediately precede a, notated as t1(a) below;
Whether a has been found to participate in a race condition with later thread 1 actions; such an a is said to be marked.
   In addition, the method maintains the number of thread 1 operations since the last thread 0 operation in the current schedule (if any); this value is kept in the program variable count1 below.

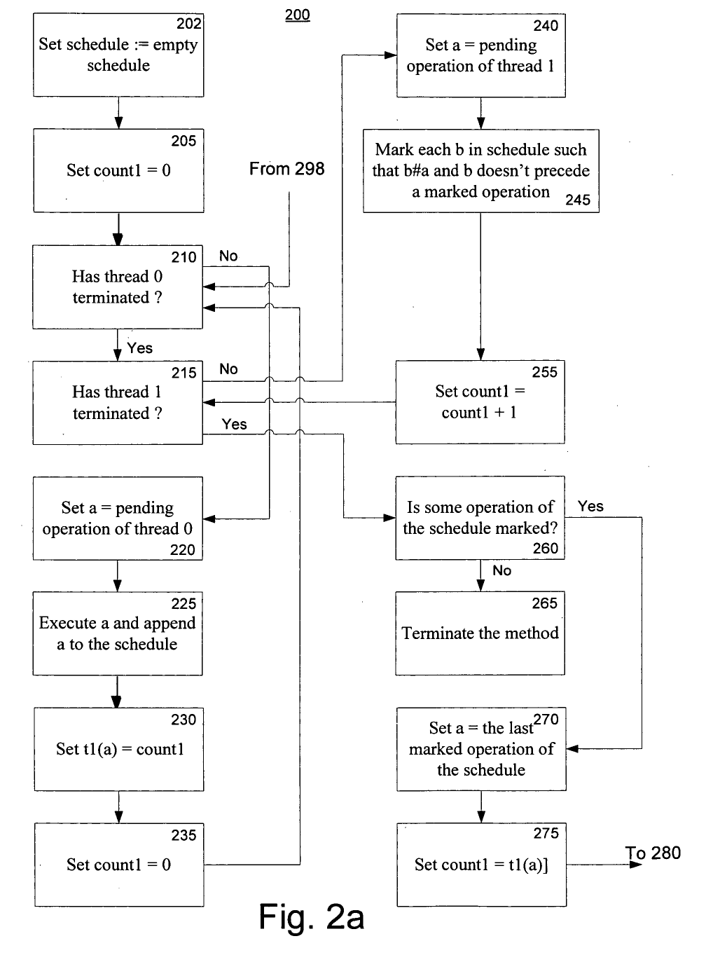

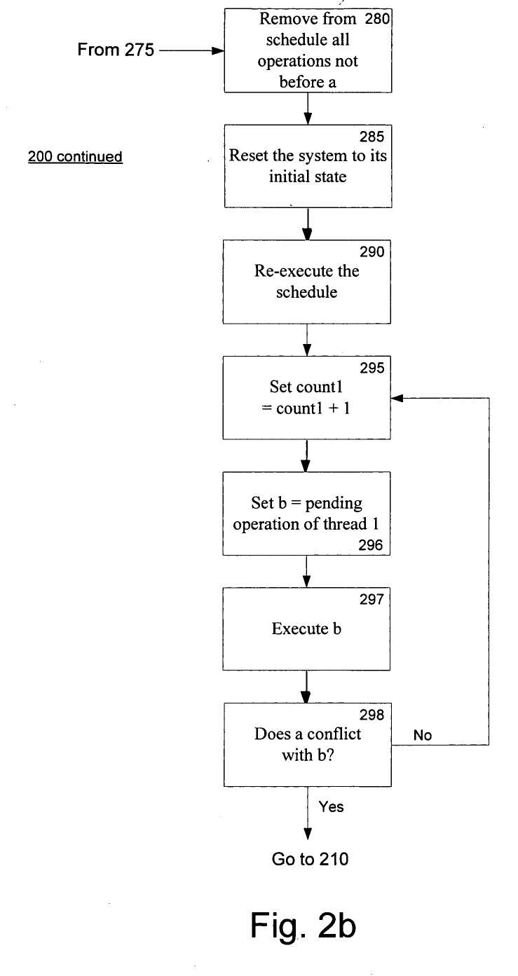

A method 200 for two threads is illustrated in FIGS. 2a and 2b. Initially, the sequence of thread 0 operations is empty [step 210], and count1 is 0 [step 205]. The algorithm proceeds as follows:
1. If thread 0 has not terminated [step 210], let a be the pending operation of thread 0 [step 220], append to the end of the recorded schedule the operation a [step 225], set t1(a) to count1 [step 230], set count1 to 0 [step 235], and repeat step 210 until thread 0 has terminated. After thread 0 has terminated, inquire if thread 1 has terminated, go to step 215.
2. If thread 1 is not terminated [step 215], let a be the pending operation of thread 1 [step 240]. Mark every operation b of the recorded schedule that conflicts with a and does not precede another marked operation of the recorded schedule [step 245]. Increment count1 by 1 [step 255] and go to step 215.
3. If no operation of the recorded schedule is marked [step 260], terminate the algorithm [step 265]. Otherwise, let a be the last marked operation [step 270]. Set count1 to t1(a) [step 275], remove from the schedule all operations not before a [step 280], reset the system to its initial state [step 285] and re-execute all of the operations of the schedule [step 290]
4. Increment count1 [step 295]. Let b be the current pending operation of thread 1 [step 296]; execute b [step 297]. If b does not conflict with a [step 298], go to step 210; otherwise, go to step 295.

This two thread method requires space that is only linear in the maximum number of thread 0 operations, and is more efficient than the general method. No vector clocks are needed. To illustrate this method, consider a system where thread 0, a first thread, performs operations a,b,c in that order, and that the operations of thread 1, a second thread, are named A,B,C. Assume further that the conflict relation is given by a#A, b#B, c#A. A schedule is represented as a sequence of items of the form op t1(op) marked, where T denotes the Boolean “true” and F denotes the Boolean “false”. For example, the item “a0F” means operation a, with t1(a)=0 and marked(a)=false. Table 2 provides an example of a two thread method. The column “Step” gives the step number of the algorithm, “schedule” gives the actual current schedule, “recorded” gives how this schedule is recorded in the data structure described above, “1c” gives the value of lastconflict, count1 gives the value of count1, and comments describes the actions taken.

TABLE 2
Two Thread Example

| Step | schedule | recorded | count 1 | comments |
|---|---|---|---|---|
| 1 | <empty> | <empty> | 0 | a the minimal extension of <empty> |
| 1 | a | a0F | 0 | b the minimal extension of a |
| 1 | ab | a0F, b0F | 0 | c the minimal extension of ab |
| 1 | abc | a0F, b0F, c0F | 0 | thread 0 terminated |
| 2 | abc | a0F, b0F, c0F | 0 | A minimal extension of abc; a#A, c#A |
| 2 | abcA | a0T, b0F, c0aT | 1 | B the minimal extension of abcA |
| 2 | abcAB | a0T, b0F, c0aT | 2 | C the minimal extension of abcAB |
| 2 | abcABC | a0T, b0F, c0aT | 3 | abcABC complete |
| 3 | abcABC | a0T, b0F, c0aT | 3 | c the last marked op |
| 4 | ab | a0T, b0F | 0 | A the pending op of thread 1; c#A |
| 1 | abA | a0T, b0F | 1 | c the minimal extension of abA |
| 1 | abAc | a0T, b0F, c1F | 0 | thread 0 terminated |
| 2 | abAc | a0T, b0F, c1F | 0 | B the pending op of thread 1; B#b |
| 2 | abAcB | a0T, b0T, c1F | 1 | C the pending op of thread 1 |
| 2 | abAcBC | a0T, b0T, c1F | 2 | abAcBC complete |
| 3 | abAcBC | a0T, b0T, c1F | 2 | b the last marked op |
| 4 | a | a0T | 0 | A pending op of thread 1 |
| 4 | aA | a0T | 1 | B pending op of thread 1; b#B |
| 1 | aAB | a0T | 2 | b minimal extension of aAB |
| 1 | aABb | a0T, b2F | 0 | c minimal extension of aABb |
| 1 | aABbc | a0T, b2F, c0F | 0 | thread 0 terminated |
| 2 | aABbc | a0T, b2F, c0F | 0 | C pending op of thread 1 |
| 2 | aABbcC | a0T, b2F, c0F | 1 | aABbcC complete |
| 3 | aABbcC | a0T, b2F, c0F | 1 | a the last marked op |
| 4 | <empty> | <empty> | 0 | A pending op of thread 1, a#A |
| 1 | A | <empty> | 1 | a minimal extension of A |
| 1 | Aa | a1F | 0 | b the minimal extension of Aa |
| 1 | Aab | a1F, b0F | 0 | c the minimal extension of Aab |
| 1 | Aabc | a1F, b0F, c0F | 0 | thread 0 terminated |
| 2 | Aabc | a1F, b0F, c0F | 0 | B the minimal extension of Aabc, b#B |
| 2 | AabcB | a1F, b0T, c0F | 1 | C the minimal extension of AabcB |
| 2 | AabcBC | a1F, b0T, c0F | 2 | AabcBC complete |
| 3 | AabcBC | a1F, b0T, c0F | 2 | b the last marked op |
| 4 | Aa | a1F | 0 | B pending op of thread 1; B#b |
| 1 | AaB | a1F | 1 | b the minimal extension of AaB |
| 1 | AaBb | a1F, b1F | 0 | c the minimal extension of AaBb |
| 1 | AaBbc | a1F, b1F, c0F | 0 | thread 0 terminated |
| 2 | AaBbc | a1F, b1F, c0F | 0 | C the minimal extension of AaBbc |
| 2 | AaBbcC | a1F, b1F, c0F | 1 | AaBbcC complete |
| 3 | AaBbcC | a1F, b1F, c0F | 1 | no marked operations; algorithm terminates |

In some embodiments of the method for two threads, each marked operation stores the last preceding marked operation, and the last operation of the whole recorded schedule is maintained. In this embodiment, these datum are updated when an operation is marked.

Exemplary Computing Device

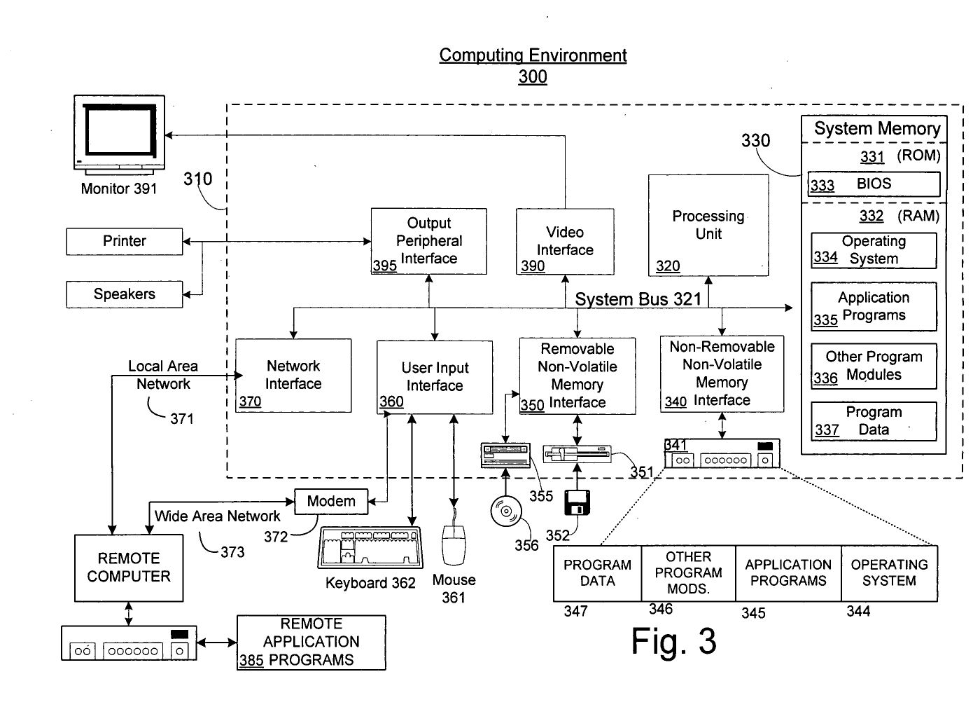

FIG. 3 and the following discussion are intended to provide a brief general description of a suitable computing environment in which embodiments of the invention may be implemented. While a general purpose computer is described below, this is but one single processor example, and embodiments of the invention with multiple processors may be implemented with other computing devices, such as a client having network/bus interoperability and interaction. Thus, embodiments of the invention may be implemented in an environment of networked hosted services in which very little or minimal client resources are implicated, e.g., a networked environment in which the client device serves merely as an interface to the network/bus, such as an object placed in an appliance, or other computing devices and objects as well. In essence, anywhere that data may be stored or from which data may be retrieved is a desirable, or suitable, environment for operation.

Although not required, embodiments of the invention can also be implemented via an operating system, for use by a developer of services for a device or object, and/or included within application software. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that various embodiments of the invention may be practiced with other computer configurations. Other well known computing systems, environments, and/or configurations that may be suitable for use include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. Embodiments of the invention may also be practiced in distributed computing environments where tasks are performed by remote processing devices that are linked through a communications network/bus or other data transmission medium. In a distributed computing environment, program modules may be located in both local and remote computer storage media including memory storage devices and client nodes may in turn behave as server nodes.

With reference to FIG. 3, an exemplary system for implementing an embodiment of the invention includes a general purpose computing device in the form of a computer system 310. Components of computer system 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures.

Computer system 310 typically includes a variety of computer readable media. Computer readable media can be any available media that can be accessed by computer system 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer system 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 333, application programs 335, other program modules 336, and program data 337.

The computer system 310 may also include other removable/non-removable, volatile/nonvolatile computer storage media. By way of example only, FIG. 3 illustrates a hard disk drive 331 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 331 is typically connected to the system bus 321 through a non-removable memory interface such as interface 330, and magnetic disk drive 351 and optical disk drive 355 are typically connected to the system bus 321 by a removable memory interface, such as interface 350.

The drives and their associated computer storage media discussed above and illustrated in FIG. 3 provide storage of computer readable instructions, data structures, program modules and other data for the computer system 310. In FIG. 3, for example, hard disk drive 331 is illustrated as storing operating system 333, application programs 335, other program modules 336, and program data 337. Note that these components can either be the same as or different from operating system 333, application programs 335, other program modules 336, and program data 337. Operating system 333, application programs 335, other program modules 336, and program data 337 are given different numbers here to illustrate that, at a minimum, they are different copies. A user may enter commands and information into the computer system 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390, which may in turn communicate with video memory (not shown). In addition to monitor 391, computer systems may also include other peripheral output devices such as speakers 397 and printer 396, which may be connected through an output peripheral interface 395.

The computer system 310 may operate in a networked or distributed environment using logical connections to one or more remote computers, such as a remote computer 380. The remote computer 380 may be a personal computer, a server, a router, a network PC, a peer device or other common network node, and typically includes many or all of the elements described above relative to the computer system 310, although only a memory storage device 381 has been illustrated in FIG. 3. The logical connections depicted in FIG. 3 include a local area network (LAN) 371 and a wide area network (WAN) 373, but may also include other networks/buses. Such networking environments are commonplace in homes, offices, enterprise-wide computer networks, intranets and the Internet.

When used in a LAN networking environment, the computer system 310 is connected to the LAN 371 through a network interface or adapter 370. When used in a WAN networking environment, the computer system 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer system 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, includes servers, building-block services, such as Web-based data storage, and downloadable device software. While exemplary embodiments herein are described in connection with software residing on a computing device, one or more portions of an embodiment of the invention may also be implemented via an operating system, application programming interface (API) or a “middle man” object between any of a coprocessor, a display device and a requesting object, such that operation may be performed by, supported in or accessed via all of .NET™'s languages and services, and in other distributed computing frameworks as well.

As mentioned above, while exemplary embodiments of the invention have been described in connection with various computing devices and network architectures, the underlying concepts may be applied to any computing device or system in which it is desirable to implement a concurrent system testing method. Thus, the methods and systems described in connection with embodiments of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by embodiments of the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention.

While aspects of the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the claimed invention should not be limited to any single embodiment, but rather should be construed in breadth and scope in accordance with the appended claims.

What is claimed:

1. A method of testing a concurrent computer system, the method comprising:
(a) choosing at least one binary, symmetric conflict relation on operations of the system such that all pairs of operations chosen from different threads either conflict or commute, the at least one conflict relation defining a conflict equivalence class of schedules, each schedule comprising a sequence of operations; and
(b) executing a set of complete schedules, wherein the set of complete schedules includes exactly one schedule from the conflict equivalence class of schedules;
wherein the complete schedule of the system comprises a sequence of operations where all thread executions terminate, wherein the system is reset to an initial state between schedule executions, and two schedules are conflict-equivalent if a first schedule can be converted to a second schedule by repeatedly swapping pairs of adjacent non-conflicting operations from different threads.

2. The method of claim 1, wherein the step of executing a set of complete schedules further comprises:
choosing a linear ordering on threads of the system before executing the set of complete schedules, each schedule in the set of complete schedules comprising a schedule that is normal, wherein a normal schedule is a lexicographically smallest schedule in a conflict equivalent class.

3. The method of claim 2, wherein the step of executing a set of complete schedules comprises:
(b1) identifying a current schedule, wherein the current schedule is a last schedule executed in the set of complete schedules, the current schedule initially set to an empty schedule;
(b2) identifying a set of schedules yet to be examined, the set of schedules initially set to an empty set;
(b3) adding to the set of schedules yet to be examined a new schedule for every operation b of a current schedule that immediately causally precedes the last operation a of the current schedule, wherein the new schedule is obtained by removing from the current schedule all operations that causally follow b in the current schedule, and appending a to the resulting schedule, and wherein the new schedule is added if the new schedule is lexicographically greater than the current schedule, and the new schedule is normal, and when extended by an operation, is a lexicographically smallest schedule in a conflict equivalent class, and wherein a first operation immediately causally precedes a second operation of a schedule if the first operation causally precedes the second operation and no third operation of the schedule is causally between the first operation and the second operation; and
(b4) terminating the method if the current schedule is complete and the set of schedules yet to be examined is empty.
(b5) if the current schedule is a complete schedule, setting the current schedule to be the lexicographically smallest schedule of the set of schedules yet to be examined, removing the current schedule from set of schedules yet to be examined, resetting the system to the initial state, re-executing the current schedule on the system, and returning to step (b3).
(b6) if the current schedule is not a complete schedule, executing on the system the next operation of the lexicographically smallest non-terminated thread, adding the executed operation to the current schedule, and returning to step (b3) until step (b4) terminates the method.

4. A method of testing a concurrent computer system having two threads, the method comprising:
(a) choosing at least one binary, symmetric conflict relation on operations of the system such that all pairs of operations chosen from a first thread and a second thread either conflict or commute, the at least one conflict relation defining a conflict equivalence class of schedules;
(b) identifying a current schedule comprising a sequence of operations from threads;
(c) maintaining a record of the current schedule, including at least the sequence of the first thread operations and the number of the second thread operations immediately preceding each first thread operation, the current schedule initially being empty;
(d) maintaining, for each first thread operation of the current schedule, a Boolean variable indicating whether that operation is marked;
(e) repeatedly executing the first thread operations until the first thread terminates, adding the corresponding operations to the current schedule, the added first thread operations recorded as unmarked;
(f) repeatedly executing the second thread operations until the second thread terminates, adding each such operation to the current schedule and, before executing further second thread operations, marking all first thread operations of the current schedule that conflict with the executed second thread operation and are not followed by a later-marked first thread operation;
(g) terminating the method if no first thread operation is marked;
(h) resetting the system state, removing from the current schedule all operations after a last-marked first thread operation inclusive, and re-executing the current schedule on the system;
(i) repeatedly executing second thread operations until executing an operation that conflicts with the pending first thread operation, and adding the executed operations to the current schedule; and
(j) returning to step (e) until the method terminates at step (g);
wherein the complete schedule of the system comprises of a sequence of operations where all thread executions terminate.

5. A computer-readable medium having computer-executable instructions for performing a method of transferring messages in a computer, the method comprising:
(a) choosing at least one binary, symmetric conflict relation on operations of the system such that all pairs of operations chosen from different threads either conflict or commute, the at least one conflict relation defining a conflict equivalence class of schedules, each schedule comprising a sequence of threads; and
(b) executing a set of complete schedules, wherein the set of complete schedules includes exactly one schedule from the conflict equivalence class of schedules;
wherein the complete schedule of the system comprises a sequence of operations where all thread executions terminate, wherein the system is reset to an initial state between schedule executions, and two schedules are conflict-equivalent if a first schedule can be converted to a second schedule by repeatedly swapping pairs of adjacent non-conflicting operations from different threads.

6. The computer-readable medium of claim 5, wherein the step of executing a set of complete schedules further comprises:
choosing a linear ordering on threads of the system before executing the set of complete schedules, each schedule in the set of complete schedules comprising a schedule that is normal, wherein a normal schedule is a lexicographically smallest schedule in a conflict equivalent class.

7. The computer-readable medium of claim 6, wherein the step of executing a set of complete schedules comprises:
(b1) identifying a current schedule, wherein the current schedule is a last schedule executed in the set of complete schedules, the current schedule initially set to an empty schedule;
(b2) identifying a set of schedules yet to be examined, the set of schedules initially set to an empty set;
(b3) adding to the set of schedules a new schedule for every operation b of a current schedule that immediately causally precedes the last operation a of the current schedule, wherein the new schedule is obtained by removing from the current schedule all operations that causally follow b in the current schedule, and appending a to the resulting schedule, and the new schedule is normal, and when extended by an operation, is a lexicographically smallest schedule in a conflict equivalent class, and wherein the new schedule is added if the new schedule is lexicographically greater than the current schedule, and wherein a first operation immediately causally precedes a second operation of a schedule if the first operation causally precedes the second operation and no third operation of the schedule is causally between the first operation and the second operation; and
(b4) terminating the method if the current schedule is complete and the set of schedules yet to be examined is empty.
(b5) if the current schedule is a complete schedule, setting the current schedule to be the lexicographically smallest schedule of the set of schedules yet to be examined, removing the current schedule from set of schedules yet to be examined, resetting the system to an initial state, re-executing the current schedule on the system, and returning to step (b3).
(b6) if the current schedule is not a complete schedule, executing on the system a next operation of the lexicographically smallest non-terminated thread, adding the next operation to the current schedule, and returning to step (b3) until step (b4) terminates the method.
